(19) United States
(12) Patent Application Publication
(10) Pub. No.: US 2011/0197165 A1
(43) Pub. Date: Aug. 11, 2011

(54) METHODS AND APPARATUS FOR ORGANIZING A COLLECTION OF WIDGETS ON A MOBILE DEVICE DISPLAY

(76) Inventors: Vasily Filippov, Saint-Petersburg (RU); Yaroslav Goncharov, Leningrad Region (RU)

(21) Appl. No.: 12/701,026

(22) Filed: Feb. 5, 2010

(51) Int. Cl. G06F 3/048

(52) U.S. Cl. 715/841

(57) ABSTRACT

A system renders a collection of widgets, hosted by a respective widget engine, on a mobile device display. The collection comprises at least one first widget representation that, when selected, invokes a first widget, and a first widget sub-collection representation that, when selected, invokes a plurality of widget representations. The system renders a three dimensional presentation of the collection of widgets on the mobile device display. The presentation comprises a three dimensional association between at least one of the first widget sub-collection representation and the second widget sub-collection representation. The system receives instruction to render the collection of widgets in a list view comprising at least one widget representation; and at least one widget representation associated with at least one widget sub-collection representation.

### BACKGROUND

Smart phones are mobile devices with Personal Computer (PC) like features, including an operating system, software applications, a miniature QWERTY keyboard, touch screen, etc. Smart phones run various software applications, such as email clients, and provide Internet access. These software applications, often referred to as ‘widgets’ can be installed and executed on mobile devices without additional compilation. Given the size of the touch screen, only a subset of the widgets can be rendered on the touch screen at any given time. Yet, there may be many widgets available to the user. Therefore, it is necessary to organize the widgets to facilitate the user's ability to quickly locate and execute the desired widgets.

### SUMMARY

Conventional computerized technologies for rendering widgets on a communications device, such as a smart phone, suffer from a variety of deficiencies. In particular, conventional technologies for rendering widgets are limited in that conventional technologies do not provide a convenient and portable way to organize (and share with other mobile device users) widgets available on a mobile device. Users often have many widgets downloaded onto their mobile device. Keeping the collection of widgets organized into sub-collections of widgets enables users to access those widgets efficiently. Conventional technologies do not provide a three dimensional presentation displaying the association between the sub-collections of widgets and their respective widgets. Conventional technologies do not provide users with the option to view all the widgets available on the mobile device in a list view to easily select a particular widget.

Embodiments disclosed herein significantly overcome such deficiencies and provide a system that includes a computer system and/or software executing a widget organizing process that renders a collection of widgets on a mobile device display. Widgets may be standalone applications that may be hosted by a widget system (i.e., a software service available to users for running the widgets on a graphical user interface). For example, a widget system (host) may control the placement of the widget on the mobile device display, but typically does not control its content. A widget system may host several widgets on the same page/screen of the mobile device display. Widgets may be focused applications that are generally smaller in size, and less complex than typical software applications. Widgets often take up little real estate on a display when operating. Widgets may be written in a variety of different languages. The widgets are each hosted by a respective widget engine. The collection of widget comprises at least one widget representation and/or at least one widget sub-collection representation. The widget representation, when selected, invokes a widget. The widget sub-collection representation, when selected, invokes a plurality of widget representations. Each of the plurality of widget representations may be selected to invoke either a widget or yet another widget sub-collection representation. In other words, a widget sub-collection is in itself a widget that contains multiple widget representations (or widget sub-collection representations). Thus, the collection of widgets available on the mobile device can be organized into sub-collections making it easier for users to locate a particular widget. The widgets may be grouped according to a variety of criteria, for example, widgets related to email functions might be grouped together. The sub-collections may be modified by users, and shared with other users. For example, users may upload widget sub-collection representations to the Internet where other users may download (and modify) the widget sub-collection representations for use on their mobile devices. Users may also customize the appearance of the widget sub-collections representations.

In an example embodiment, the widget organizing process applies a policy to a widget sub-collection representation restricting which widgets can be added to that widget sub-collection representation. For example, a user may create a ‘Facebook’ widget sub-collection representation. The widget organizing process applies a policy to the widget sub-collection representation to insure that only Facebook related widgets are added to this widget sub-collection representation. By enforcing the policy, the widget organizing process ensures that the widget sub-collection representation remains meaningful and useful to users.

In an example embodiment, the widget organizing process automatically organizes a subset of the widgets on the mobile device into at least one widget sub-collection representation, and then renders that widget sub-collection representation on the mobile device display. In another example embodiment, the widget organizing process detects that a subset of the widgets has not been selected by a user within a predetermined period of time, and identifies the subset for compilation into at least one widget sub-collection representation. In other words, the widget organizing process automatically organizes unused widget into a widget sub-collection representation cleaning the mobile device display of unused widget representations. The widget organizing process allows a user to modify the widget sub-collection representation, and even provides recommendations for that modification.

In an example embodiment, the widget organizing process detects that too many widget are rendered on the mobile device display. If a user tries to add widgets to the mobile device display above a display threshold, the widget organizing process transmits a recommendation to the user to organize a subset of the widgets into at least one widget sub-collection representation. For example, if a user tries to add several widgets related to Facebook, the widget organizing process transmits a recommendation to the user to add those widgets to a widget sub-collection representation that's restricted for only Facebook related widgets.

In an example embodiment, the widget organizing process allows a user to customize an appearance associated at least one widget sub-collection representation. The user may select a canvas to render on the mobile device display along with the widget sub-collection representation. This allows the user to easily distinguish different widget sub-collection representations on the mobile device display.

In an example embodiment, the widget organizing process allows a user to create and/or modify widget sub-collection representations. The user may then upload the widget sub-collection representations to the Internet, allowing other users to download them, and make additional modifications (i.e., add or remove widgets, change an appearance, change the locations of various widgets within the widget sub-collection representation, etc.).

In an example embodiment, the widget organizing process renders a three dimensional presentation of the collection of widgets on the mobile device display showing the relationship between nested widget sub-collection representations (i.e., a widget sub-collection representation may contain multiple widget sub-collection representations). The widget organizing process allows a user to select, via the three dimensional presentation, any of the widget representations and/or widget sub-collection representations to render that selection on the mobile device display.

In an example embodiment, the widget organizing process receives instructions to render all of the widgets (available on the mobile device) in a list view. The user may select any widget representation from the list view. The widget organizing process then renders the selected widget representation on the mobile device display along with any other widget representations associated with the selected widget representation. In other words, if the selected widget representation is compiled into a widget sub-collection representation, that widget sub-collection representation is rendered on the mobile device display. Thus, selecting a particular widget representation from the list view is an efficient method to navigate to a particular widget sub-collection representation. In an example embodiment, for each widget representation that is associated with more than one widget sub-collection representation, the widget organizing process renders an instance of the widget representation in the list view for each of the plurality of widget sub-collection representations. Thus, a user may quickly navigate to a particular widget sub-collection representation by selecting the appropriate widget representation from the list view even if that widget representation is rendered on multiple widget sub-collection representations. In an example embodiment, the widget organizing process associates the widget representation in the list view with a class of widgets. The user may hide a particular class of widgets from the list view to reduce the amount of widget representations rendered on the mobile device display. The user may then restore the class of widgets. The user may also hide (and restore) individual widget representations from the list view. The user may organize the list of widget representations according to various criteria, for example, alphabetically, by type, grouped according to widget sub-collection representation, most frequently used, etc. The user may also manipulate the order in which the widget representations are rendered on the mobile device display. To do so, the user slides a finger across the screen of the mobile device display to re-order the widget representations in the list view (i.e., drag and drop).

Other embodiments disclosed herein include any type of computerized device, workstation, handheld or laptop computer, or the like configured with software and/or circuitry (e.g., a processor) to process any or all of the method operations disclosed herein. In other words, a computerized device such as a computer or a data communications device or any type of processor that is programmed or configured to operate as explained herein is considered an embodiment disclosed herein.

Other embodiments disclosed herein include software programs to perform the steps and operations summarized above and disclosed in detail below. One such embodiment comprises a computer program product that has a computer-readable medium including computer program logic encoded thereon that, when performed in a computerized device having a coupling of a memory and a processor, programs the processor to perform the operations disclosed herein. Such arrangements are typically provided as software, code and/or other data (e.g., data structures) arranged or encoded on a computer readable medium such as an optical medium (e.g., CD-ROM), floppy or hard disk or other a medium such as firmware or microcode in one or more ROM or RAM or PROM chips or as an Application Specific Integrated Circuit (ASIC). The software or firmware or other such configurations can be installed onto a computerized device to cause the computerized device to perform the techniques explained as embodiments disclosed herein.

It is to be understood that the system disclosed herein may be embodied strictly as a software program, as software and hardware, or as hardware alone. The embodiments disclosed herein, may be employed in data communications devices and other computerized devices and software systems for such devices such as those manufactured by Spb Software, Inc. of Hackensack, N.J.

### BRIEF DESCRIPTION OF THE DRAWINGS

The foregoing will be apparent from the following description of particular embodiments disclosed herein, as illustrated in the accompanying drawings in which like reference characters refer to the same parts throughout the different views. The drawings are not necessarily to scale, emphasis instead being placed upon illustrating the principles disclosed herein.

FIG. 1 shows a high-level block diagram of a computer system according to one embodiment disclosed herein.

FIG. 2 shows an example screenshot of a collection of widgets.

FIG. 3 shows an example screenshot of a plurality of widgets rendered on a mobile device display.

FIG. 4 shows an example screenshot of a mobile device display rendering a widget sub-collection representation along with a plurality of widget representations.

FIG. 5 shows an example screenshot of a three dimensional presentation rendering an association between a collection of widgets and an associated widget sub-collection representation.

FIG. 6 shows an example screenshot of a mobile device display rendering a plurality of widgets.

FIG. 7 shows an example screenshot of a list view containing a plurality of widgets available to a user.

FIG. 8 shows an example screenshot of a mobile device display rendering a plurality of widget representations including a widget representation selected from a list view.

FIG. 9 illustrates a flowchart of a procedure performed by the system of FIG. 1, when the widget organizing process renders a collection of widgets hosted by a respective widget engine, on a mobile device display, according to one embodiment disclosed herein.

FIG. 10 illustrates a flowchart of a procedure performed by the system of FIG. 1, when the widget organizing process renders a collection of widgets, and automatically organizes a subset of the widgets into at least one widget sub-collection representation, according to one embodiment disclosed herein.

FIG. 11 illustrates a flowchart of a procedure performed by the system of FIG. 1, when the widget organizing process renders a collection of widgets, and detects that a number of widgets rendered on the mobile device display has exceeded a display threshold, according to one embodiment disclosed herein.

FIG. 12 illustrates a flowchart of a procedure performed by the system of FIG. 1, when the widget organizing process renders a collection of widgets, and allows at least one user to transfer the widget sub-collection representation to a storage system for retrieval by at least one other user, according to one embodiment disclosed herein.

FIG. 13 illustrates a flowchart of a procedure performed by the system of FIG. 1, when the widget organizing process renders a collection of widgets, and renders a three dimensional presentation of the collection of widgets on the mobile device display, according to one embodiment disclosed herein.

FIG. 14 illustrates a flowchart of a procedure performed by the system of FIG. 1, when the widget organizing process renders a collection of widgets, and receives instruction to render the collection of widgets in a list view, according to one embodiment disclosed herein.

FIG. 15 illustrates a flowchart of a procedure performed by the system of FIG. 1, when the widget organizing process receives instruction to render the collection of widgets in a list view, according to one embodiment disclosed herein.

FIG. 16 illustrates a flowchart of a procedure performed by the system of FIG. 1, when the widget organizing process allows a user to hide at least one class of widgets from the list view, according to one embodiment disclosed herein.

### DETAILED DESCRIPTION

Embodiments disclosed herein include a computer system executing a widget organizing process that renders a collection of widgets on a mobile device display. The widgets are each hosted by a respective widget engine. The collection of widget comprises at least one widget representation and/or at least one widget sub-collection representation. The widget representation, when selected, invokes a widget. The widget sub-collection representation, when selected, invokes a plurality of widget representations. Each of the plurality of widget representations may be selected to invoke either a widget or yet another widget sub-collection representation. In other words, a widget sub-collection is in itself a widget that contains multiple widget representations (or widget sub-collection representations). Thus, the collection of widgets available on the mobile device can be organized into sub-collections making it easier for users to locate a particular widget.

In an example embodiment, the widget organizing process renders a three dimensional presentation of the collection of widgets on the mobile device display showing the relationship between nested widget sub-collection representations (i.e., a widget sub-collection representation may contain multiple widget sub-collection representations). The widget organizing process allows a user to select, via the three dimensional presentation, any of the widget representations and/or widget sub-collection representations to render that selection on the mobile device display.

In an example embodiment, the widget organizing process receives instructions to render all of the widgets (available on the mobile device) in a list view. The user may select any widget representation from the list view. The widget organizing process then renders the selected widget representation on the mobile device display along with any other widget representations associated with the selected widget representation. In other words, if the selected widget representation is compiled into a widget sub-collection representation, that widget sub-collection representation is rendered on the mobile device display.

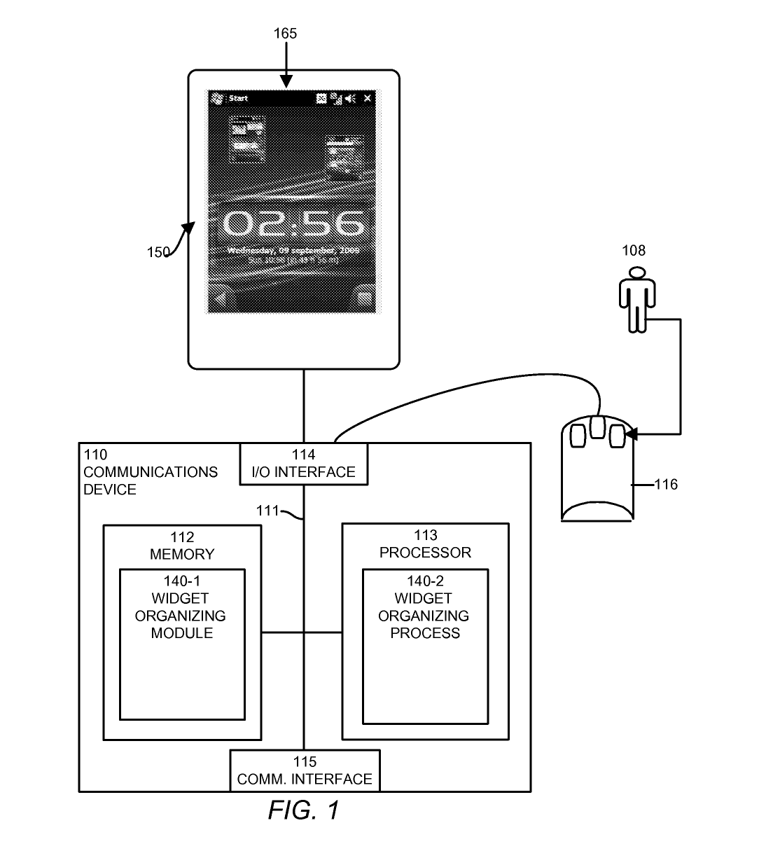

FIG. 1 is a block diagram illustrating example architecture of a mobile device 110 that executes, runs, interprets, operates or otherwise performs a widget organizing module 140-1 and widget organizing process 140-2 suitable for use in explaining example configurations disclosed herein. The mobile device 110 may be any type of computerized device such as a personal computer, workstation, portable computing device, console, laptop, network terminal or the like. An input device 116 (e.g., one or more user/developer controlled devices such as a keyboard, mouse, touch screen, etc.) couples to processor 113 through I/O interface 114, and enables a user 108 to provide input commands, and generally control a graphical user interface that the widget organizing module 140-1 and process 140-2 provides on the mobile device display 150 (rendering a collection of widgets 165). As shown in this example, the mobile device 110 includes an interconnection mechanism 111 such as a data bus or other circuitry that couples a memory system 112, a processor 113, an input/output interface 114, and a communications interface 115. The communications interface 115 enables the mobile device 110 to communicate with other devices (i.e., other computers) on a network (not shown).

The memory system 112 is any type of computer readable medium, and in this example, is encoded with a widget organizing module 140-1 as explained herein. The widget organizing module 140-1 may be embodied as software code such as data and/or logic instructions (e.g., code stored in the memory or on another computer readable medium such as a removable disk) that supports processing functionality according to different embodiments described herein. During operation of the mobile device 110, the processor 113 accesses the memory system 112 via the interconnect 111 in order to launch, run, execute, interpret or otherwise perform the logic instructions of a widget organizing module 140-1. Execution of a widget organizing module 140-1 in this manner produces processing functionality in widget organizing process 140-2. In other words, the widget organizing process 140-2 represents one or more portions or runtime instances of a widget organizing module 140-1 (or the entire a widget organizing module 140-1) performing or executing within or upon the processor 113 in the mobile device 110 at runtime.

It is noted that example configurations disclosed herein include the widget organizing module 140-1 itself (i.e., in the form of un-executed or non-performing logic instructions and/or data). The widget organizing module 140-1 may be stored on a computer readable medium (such as a floppy disk), hard disk, electronic, magnetic, optical, or other computer readable medium. A widget organizing module 140-1 may also be stored in a memory system 112 such as in firmware, read only memory (ROM), or, as in this example, as executable code in, for example, Random Access Memory (RAM). In addition to these embodiments, it should also be noted that other embodiments herein include the execution of a widget organizing module 140-1 in the processor 113 as the widget organizing process 140-2. Those skilled in the art will understand that the mobile device 110 may include other processes and/or software and hardware components, such as an operating system not shown in this example.

The widget organizing module 140-1 can be executed on a remotely accessible computerized device via the network interface 115. In this instance, the mobile device display 150 may be displayed locally to a user 108 of the remote computer, and execution of the processing herein may be client-server based.

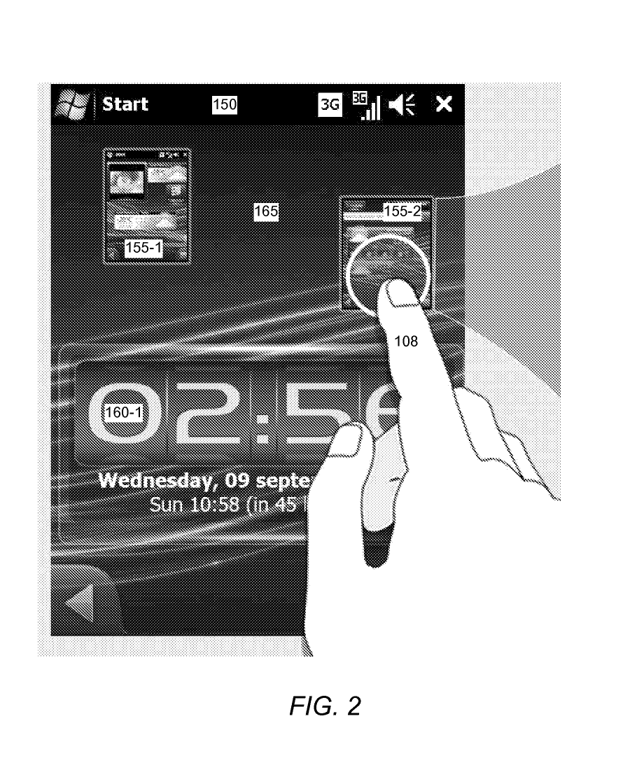

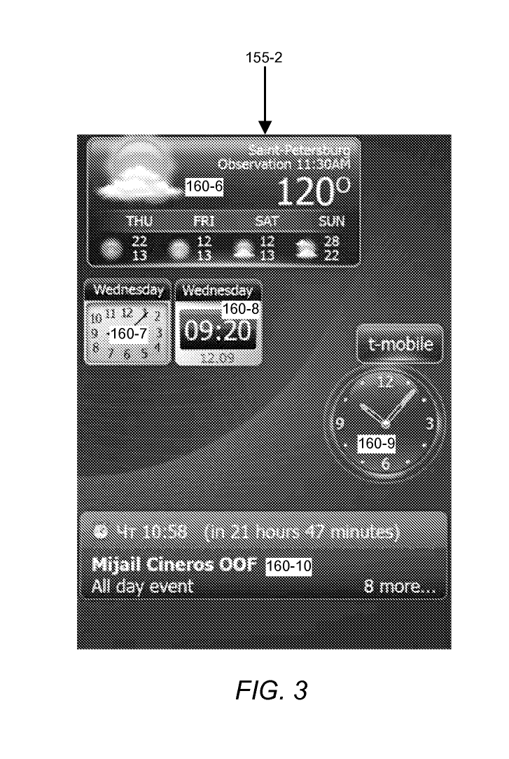

FIG. 2 is an example screenshot of a mobile device display 150 rendering a collection of widgets 165 including widget sub-collection representations 155-1 and 155-2 and widget representation 160-1. Each of the widget sub-collection representations 155-1 and 155-2 may be selected to render the widget representations 160-N (including other widget sub-collection representations 155-N) on the mobile device display 150. For example, a user 108 might select widget representation 160-2. The widget organizing process 140-2 would then render widget representation 160-2 on the mobile device display 150 as a plurality of collection of widgets 165 shown in FIG. 3.

FIG. 3 is an example screenshot of a plurality of widgets 160-N rendered on the mobile device display 150. When the user 108 in FIG. 2 selects the widget sub-collection representation 155-2, the widget organizing process 140-2 renders the plurality of widgets (160-6, 160-7, 160-8, 160-9 and 160-10) associated with widget sub-collection representation 155-2 on the mobile device display 150. In other words, widget sub-collection representation 155-2 is a widget that, when selected, renders a plurality of widget representations 160-N that are each selectable to render a respective widget.

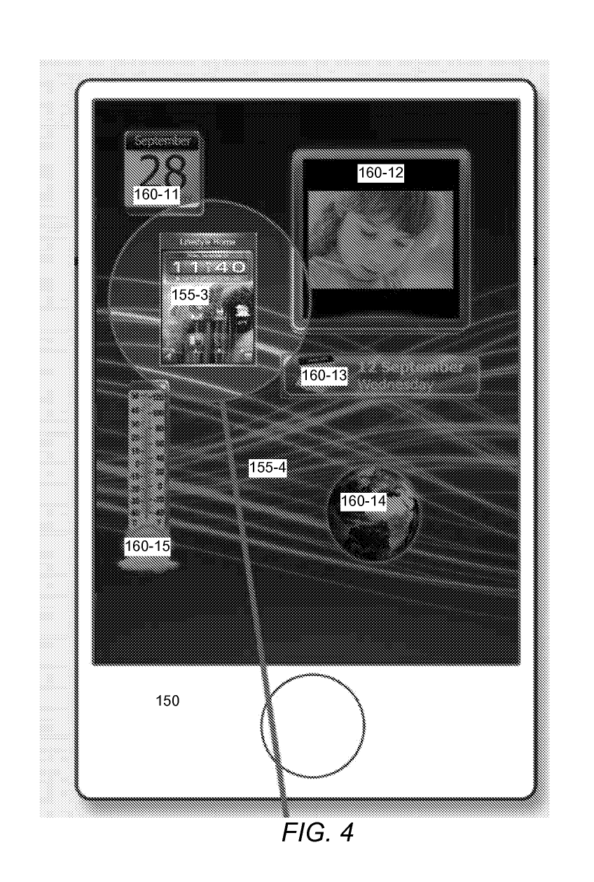

FIG. 4 is an example screenshot of a mobile device display 150 rendering a widget sub-collection representation 155-4. The widget sub-collection representation 155-4 includes a plurality of widgets (160-11, 160-12, 160-13, 160-14, and 160-15) and a widget sub-collection representation 155-3. The widget sub-collection representation 155-3 may be selected to render the plurality of widgets 160-N that are associated with widget sub-collection representation 155-3. Each of the plurality of widgets 160-N displayed in widget sub-collection representation 155-3 may also be selected to render the respective widget.

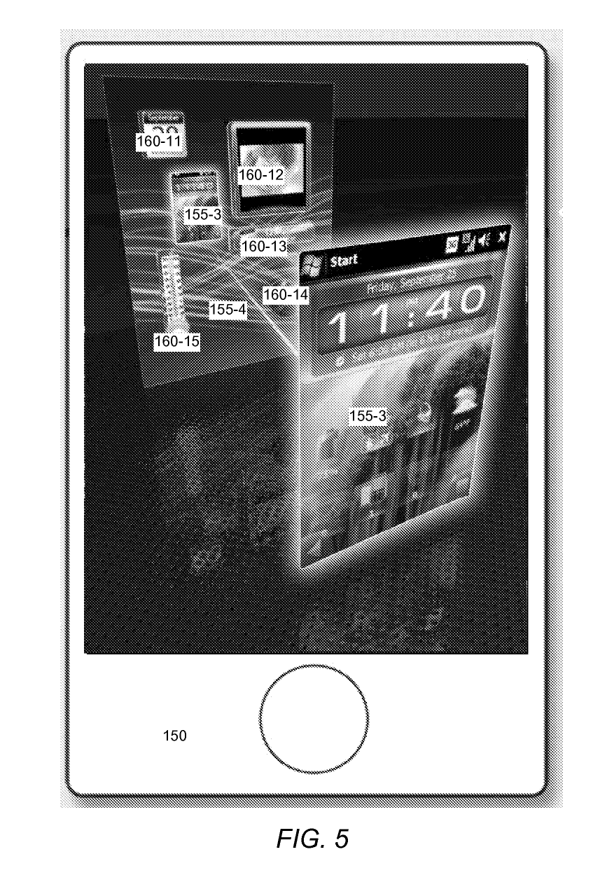

FIG. 5 is an example screenshot of a mobile device display 150 rendering a three dimensional presentation of an association between widget sub-collection representation 155-3 and widget sub-collection representation 155-4. Widget sub-collection representation 155-4 includes a plurality of widgets (160-11, 160-12, 160-13, 160-14, and 160-15) and a widget sub-collection representation 155-3. The widget organizing process 140-2 renders a three dimensional presentation displaying the nesting relationship between widget sub-collection representation 155-3 and widget sub-collection representation 155-4. In other words, widget sub-collection representation 155-4 comprises a plurality of widget representations 160-N one of which is widget sub-collection representation 155-3 which itself may be comprised of a plurality of other widget representations 160-N (including other widget sub-collection representations 155-N). In an example embodiment, a user 108 may select any of the plurality of widgets on widget sub-collection representation 155-3 or widget sub-collection representation 155-4 to render that widget on the mobile device display 150.

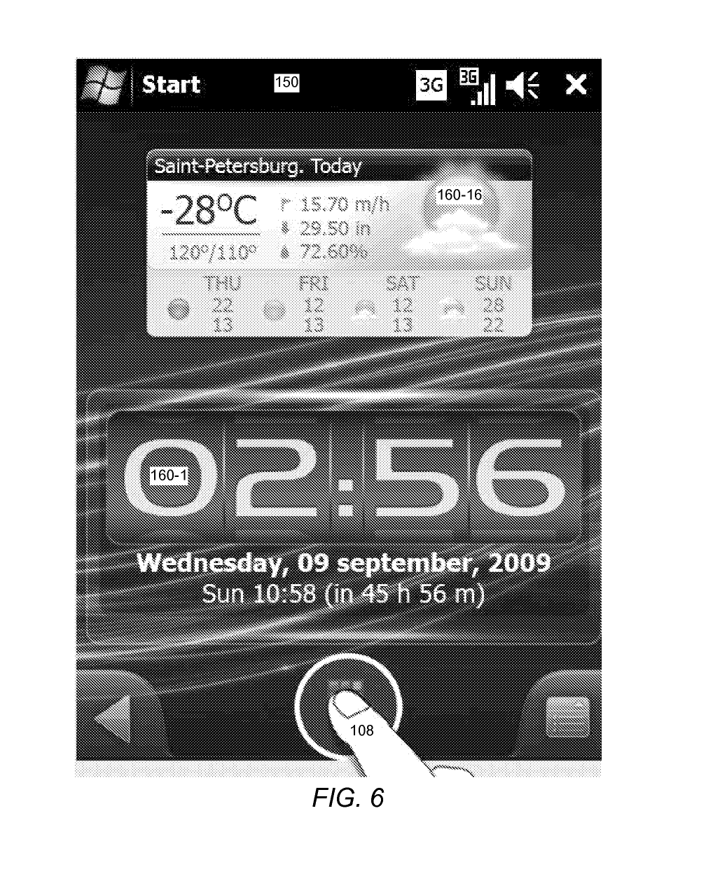

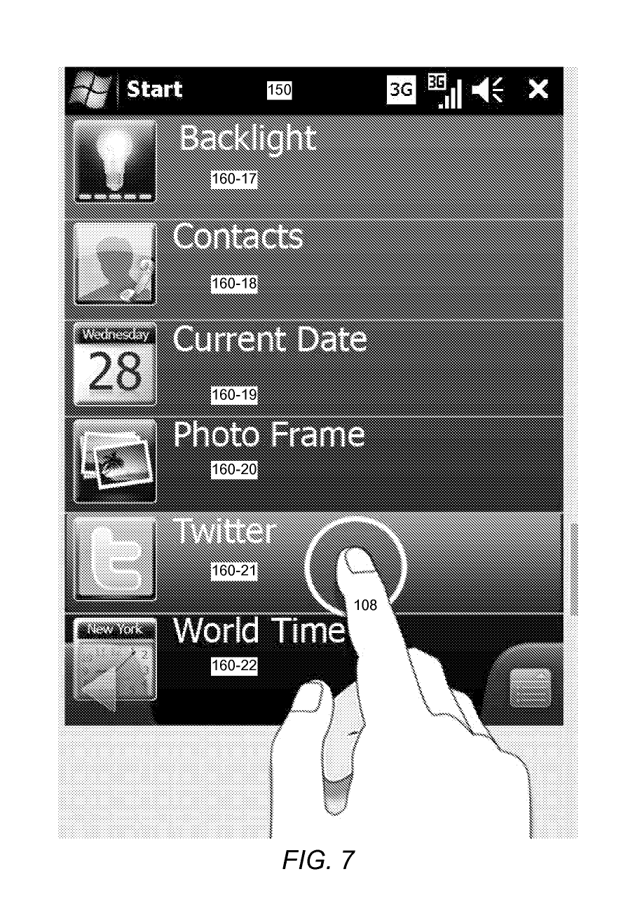

FIG. 6 is an example screenshot of a mobile device display 150 rendering a plurality of widgets (160-1 and 160-16), and a user 108 selecting an option to render a list view on the mobile device display 150. The list view, shown in FIG. 7, provides an efficient way to view all the available widgets on the mobile device 110.

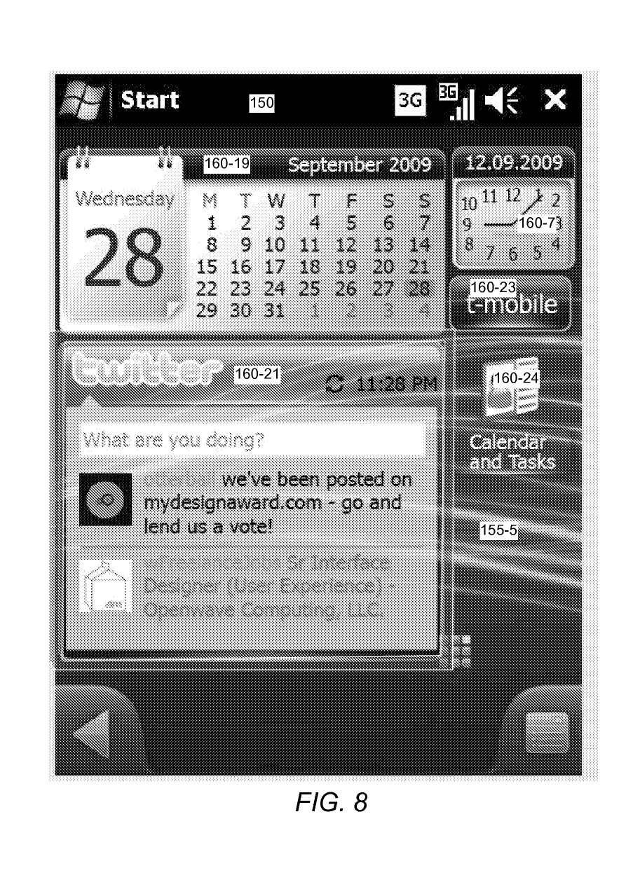

FIG. 7 is an example screenshot of a mobile device display 150 rendering a list view of a plurality of widgets (160-17, 160-18, 160-19, 160-20, 160-21 and 160-22). The list view displays a listing of the available widgets 160-N available to the user 108 on the mobile device 110. When the user 108 selects a widget 160-21 from the list view, the widget organizing process 140-2 renders the widget 160-21 along with the widget sub-collection representation 155-5 (not shown) associated with that widget 160-21 as shown in FIG. 8. In other words, if the selected widget 160-21 is compiled into a respective widget sub-collection representation 155-5, the widget organizing process 140-2 renders the widget sub-collection representation 155-5 including the selected widget 160-21 and any other widgets that are compiled in the widget sub-collection representation 155-5 (as shown in FIG. 8).

FIG. 8 is an example screenshot of a mobile device display 150 rendering a widget sub-collection representation 155-5 including plurality of widgets (160-7, 160-19, 160-21 160-23, and 160-24). In an example embodiment, the user 108 in FIG. 7 selected widget 160-21 from the list view. In response, the widget organizing process 140-2 renders the widget 160-21 with the widget sub-collection representation 155-5 on the mobile device display 150. In other words, when the user 108 selects a widget 160-21 from the list view, the widget organizing process 140-2 renders the widget sub-collection representation 155-5 associated with the widget 160-21 (along with the other widgets that are compiled into widget sub-collection representation 155-5).

Further details of configurations explained herein will now be provided with respect to a flow chart of processing steps that show the high level operations disclosed herein to perform the widget organizing process 140-2.

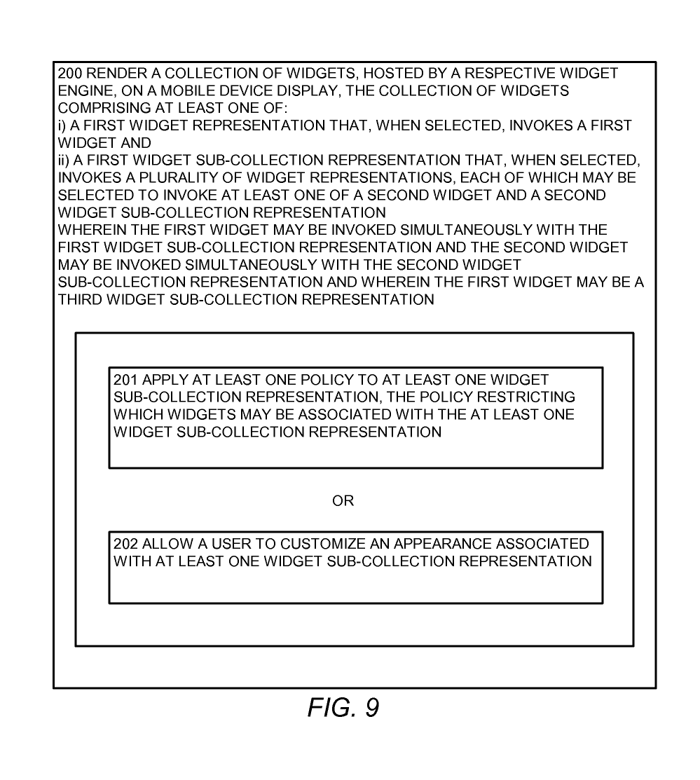

FIG. 9 is an embodiment of the steps performed by widget organizing process 140-2 when it renders a collection of widgets 165, hosted by a respective widget engine, on a mobile device display 150.

In step 200, the widget organizing process 140-2 renders a collection of widgets 165, hosted by a respective widget engine, on a mobile device display 150. The collection of widgets 165 comprises at least one of:

i) a first widget representation 160-N that, when selected, invokes a first widget and

ii) a first widget sub-collection representation 155-N that, when selected, invokes a plurality of widget representations 160-N, each of which may be selected to invoke at least one of a second widget and a second widget sub-collection representation 155-N.

In an example embodiment, the first widget may be invoked simultaneously with the first widget sub-collection representation 155-N, and the second widget may be invoked simultaneously with the second widget sub-collection representation 155-N. In another example embodiment, the first widget may be a third widget sub-collection representation 155-N. In other words, a widget sub-collection representation 155-N is in itself, a widget that may contain other widgets (or other widget sub-collection representations 155-N).

In step 201, the widget organizing process 140-2 applies at least one policy to at least one widget sub-collection representation 155-N. The policy restricts which widgets may be associated with the widget sub-collection representation 155-N. In an example embodiment, widget sub-collection representations 155-N may be restricted to contain certain types of widgets. For example, a widget sub-collection representation 155-N related to favorite Internet related widgets might execute a policy that restricts which widgets are added to that Internet widget sub-collection representation 155-N. Thus, only Internet related widgets could be added to the Internet widget sub-collection representation 155-N. If a user 108 tried to add a calendar related widget, the widget organizing process 140-2 would apply the policy, and restrict the user 108 from adding that calendar related widget to the Internet widget sub-collection representation 155-N. Applying policies to certain widget sub-collection representations 155-N results in those widget sub-collection representations 155-N remaining more meaningful to users 108 because the purpose of the widget sub-collection representations 155-N is not diluted with unrelated widgets. In another example embodiment, if the user 108 adds an Internet related widget to the mobile device display 150, the widget organizing process 140-2 may recommend that this new widget be added to the Internet widget sub-collection representation 155-N.

Alternatively, in step 202, the widget organizing process 140-2 allows a user 108 to customize an appearance associated with at least one widget sub-collection representation 155-N. In an example embodiment, a user 108 may create the widget sub-collection representation 155-N, and then fill the widget sub-collection representation 155-N with widgets. The user 108 may create an appearance associated with the widget sub-collection representation 155-N, such as selecting a canvas to be rendered along with the widgets. Selecting a canvas to be rendered along with the plurality of widgets may make it easier for the user 108 to identify the widget sub-collection representation 155-N on the mobile device display 150. Once created, the user 108 can move the widget sub-collection representation 155-N around on the mobile device display 150 by using a finger to drag the widget sub-collection representation 155-N across the screen.

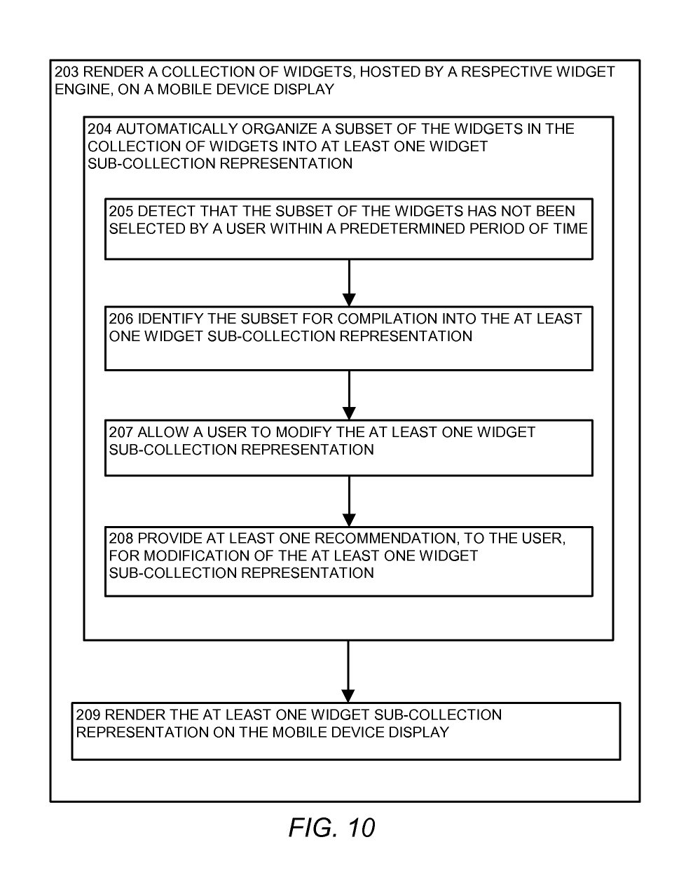

FIG. 10 is an embodiment of the steps performed by widget organizing process 140-2 when it renders a collection of widgets 165, hosted by a respective widget engine, on a mobile device display 150.

In step 203, the widget organizing process 140-2 renders a collection of widgets 165, hosted by a respective widget engine, on a mobile device display 150. The collection of widgets 165 comprises at least one of:
i) a first widget representation 160-N that, when selected, invokes a first widget and
ii) a first widget sub-collection representation 155-N that, when selected, invokes a plurality of widget representations 160-N, each of which may be selected to invoke at least one of a second widget and a second widget sub-collection representation 155-N.
   In an example embodiment, the first widget may be invoked simultaneously with the first widget sub-collection representation 155-N, and the second widget may be invoked simultaneously with the second widget sub-collection representation 155-N. In another example embodiment, the first widget may be a third widget sub-collection representation 155-N. In other words, a widget sub-collection representation 155-N is in itself, a widget that contains other widgets.

In step 204, the widget organizing process 140-2 automatically organizes a subset of the widgets in the collection of widgets 165 into at least one widget sub-collection representation 155-N. In an example embodiment, the widget organizing process 140-2 automatically organizes similar widgets into widget sub-collection representations 155-N, for example, all Facebook related widgets are organized into a Facebook widget sub-collection representation 155-N. Users 108 may modify (i.e., add or remove widgets, change the location where the widget representation is located when the widget sub-collection representation 155-N is displayed, change the appearance of the widget sub-collection representation 155-N, etc.) the automatically created widget sub-collection representations 155-N. In another example embodiment, the users 108 can download predefined widget sub-collection representations 155-N from the Internet, and then modify those widget sub-collection representations 155-N.

In step 205, the widget organizing process 140-2 detects that the subset of the widgets has not been selected by a user 108 within a predetermined period of time. In other words, the widget organizing process 140-2 identifies unused widgets.

In step 206, the widget organizing process 140-2 identifies the subset for compilation into at least one widget sub-collection representation 155-N. In an example embodiment, the widget organizing process 140-2 runs a ‘clean up’ wizard that detects unused widgets, and compiles those widgets into one or more widget sub-collection representation 155-N. Thus, if a user 108 has many widgets rendered on the mobile device display 150, the widget organizing process 140-2 ‘cleans up’ the screen of the mobile device display 150, and organizes the unused widgets into widget sub-collection representations 155-N. This reduces the clutter on the screen, making the remaining widgets rendered on the mobile device display 150 more meaningful and useful to the user 108.

In step 207, the widget organizing process 140-2 allows a user 108 to modify at least one widget sub-collection representation 155-N. Once created, the user 108 may modify the widget sub-collection representation 155-N in a number of ways. The user 108 may add widgets to the widget sub-collection representation 155-N, or remove widgets from the widget sub-collection representation 155-N. The user 108 may also customize the widget sub-collection representation 155-N to have a particular appearance such that it's more attractive, and easier to identify on the mobile device display 150.

In step 208, the widget organizing process 140-2 provides at least one recommendation, to the user 108, for modification of at least one widget sub-collection representation 155-N. For example, a user 108 downloads a new widget sub-collection representation 155-N (related to Facebook widgets) from the Internet. The widget organizing process 140-2 may suggest that the user 108 move some of the Facebook related widgets into this new widget sub-collection representation 155-N.

In step 209, the widget organizing process 140-2 renders at least one widget sub-collection representation 155-N on the mobile device display 150. Once the user 108 creates a new widget sub-collection representation 155-N (or downloads a new widget sub-collection representation 155-N from the Internet), the widget organizing process 140-2 renders the new widget sub-collection representation 155-N on the mobile device display 150. In an example embodiment, the user 108 may move this new widget sub-collection representation 155-N into an existing widget sub-collection representation 155-N (as a child widget sub-collection representation 155-3 of the existing widget sub-collection representation 155-4) creating a nesting effect of widget sub-collection representations 155-N as shown in FIG. 5.

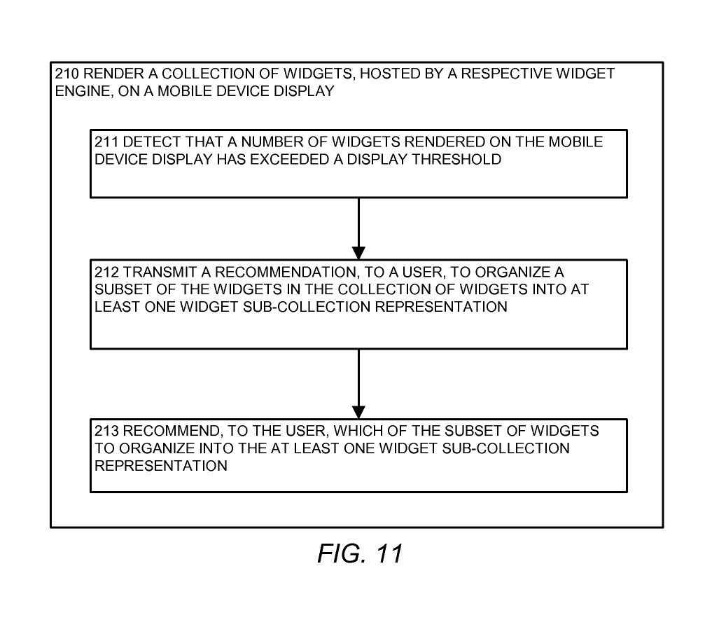

FIG. 11 is an embodiment of the steps performed by widget organizing process 140-2 when it renders a collection of widgets 165, hosted by a respective widget engine, on a mobile device display 150.

In step 210, the widget organizing process 140-2 renders a collection of widgets 165, hosted by a respective widget engine, on a mobile device display 150. The collection of widgets 165 comprises at least one of:
i) a first widget representation 160-N that, when selected, invokes a first widget and
ii) a first widget sub-collection representation 155-N that, when selected, invokes a plurality of widget representations 160-N, each of which may be selected to invoke at least one of a second widget and a second widget sub-collection representation 155-N.
   In an example embodiment, the first widget may be invoked simultaneously with the first widget sub-collection representation 155-N, and the second widget may be invoked simultaneously with the second widget sub-collection representation 155-N. In another example embodiment, the first widget may be a third widget sub-collection representation 155-N. In other words, a widget sub-collection representation 155-N is in itself, a widget that contains other widgets.

In step 211, the widget organizing process 140-2 detects that a number of widgets rendered on the mobile device display 150 has exceeded a display threshold. In an example embodiment, a user 108 tries to add one or more widgets to the mobile device display 150. The widget organizing process 140-2 detects that too many widgets are rendered on the mobile device display 150, creating a cluttered display, and making it difficult for the user 108 to easily and efficiently locate widgets.

In step 212, the widget organizing process 140-2 transmits a recommendation, to a user 108, to organize a subset of the widgets in the collection of widgets 165 into at least one widget sub-collection representation 155-N. For example, as the user 108 tries to add additional widgets to the mobile device display 150, the widget organizing process 140-2 detects that too many widgets are rendered on the mobile device display 150. The widget organizing process 140-2 transmits a message to the user 108 recommending that some of the widgets should be organized into new or existing widget sub-collection representations 155-N.

In step 213, the widget organizing process 140-2 recommends, to the user 108, which of the subset of widgets to organize into at least one widget sub-collection representation 155-N. In an example embodiment, the widget organizing process 140-2 transmits a recommendation to the user 108, specifying which of the widgets should be organized into a new or existing widget sub-collection representation 155-N. For example, the widget organizing process 140-2 may run a ‘clean up’ wizard and recommend that some unused widgets be compiled into a widget sub-collection representation 155-N. Or, the widget organizing process 140-2 may recommend that some Internet related widgets be added to existing Internet widget sub-collection representations 155-N.

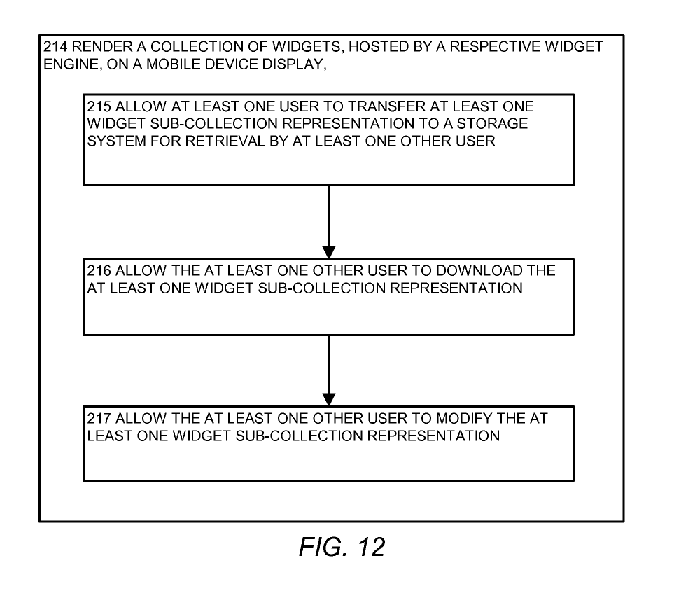

FIG. 12 is an embodiment of the steps performed by widget organizing process 140-2 when it renders a collection of widgets 165, hosted by a respective widget engine, on a mobile device display 150.

In step 214, the widget organizing process 140-2 renders a collection of widgets 165, hosted by a respective widget engine, on a mobile device display 150. The collection of widgets 165 comprises at least one of:
i) a first widget representation 160-N that, when selected, invokes a first widget and
ii) a first widget sub-collection representation 155-N that, when selected, invokes a plurality of widget representations 160-N, each of which may be selected to invoke at least one of a second widget and a second widget sub-collection representation 155-N.
   In an example embodiment, the first widget may be invoked simultaneously with the first widget sub-collection representation 155-N, and the second widget may be invoked simultaneously with the second widget sub-collection representation 155-N. In another example embodiment, the first widget may be a third widget sub-collection representation 155-N. In other words, a widget sub-collection representation 155-N is in itself, a widget that contains other widgets.

In step 215, the widget organizing process 140-2 allows at least one user 108 to transfer at least one widget sub-collection representation 155-N to a storage system for retrieval by at least one other user 108. In an example embodiment, users 108 may create widget sub-collection representations 155-N, and upload them to the Internet making them available to other users 108.

In step 216, the widget organizing process 140-2 allows the other users 108 to download the uploaded widget sub-collection representations 155-N. In an example embodiment, users 108 may download new widget sub-collection representations 155-N from the Internet to use on their mobile devices 110.

In step 217, the widget organizing process 140-2 allows the other user 108 to modify the widget sub-collection representation 155-N. Once downloaded, the users 108 may modify the new widget sub-collection representations 155-N (and then upload them to the Internet, if desired, to share with yet more users 108). In an example embodiment, the widget organizing process 140-2 transmits recommendations to the user 108 to add some of the user's 108 existing widgets into the new widget sub-collection representation 155-N.

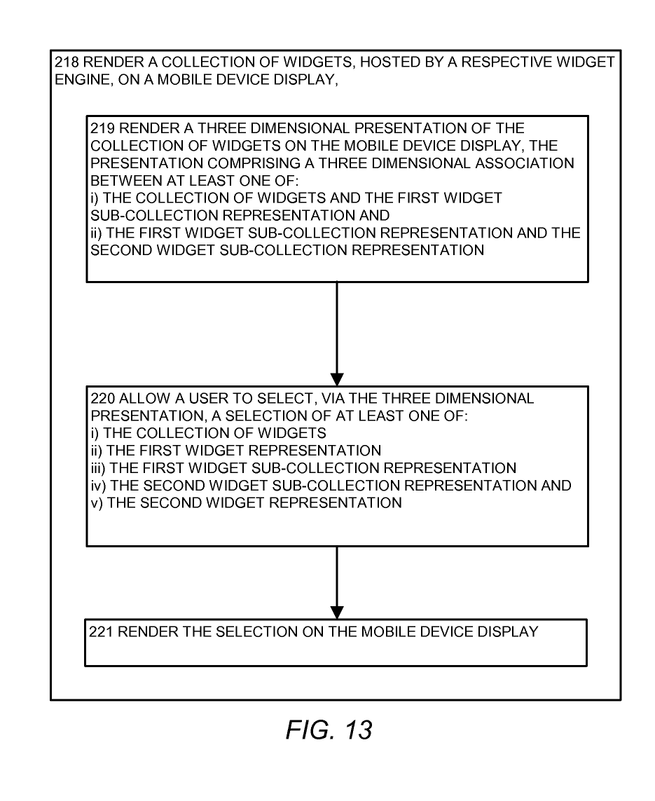

FIG. 13 is an embodiment of the steps performed by widget organizing process 140-2 when it renders a collection of widgets 165, hosted by a respective widget engine, on a mobile device display 150.

In step 218, the widget organizing process 140-2 renders a collection of widgets 165, hosted by a respective widget engine, on a mobile device display 150. The collection of widgets 165 comprises at least one of:
i) a first widget representation 160-N that, when selected, invokes a first widget and
ii) a first widget sub-collection representation 155-N that, when selected, invokes a plurality of widget representations 160-N, each of which may be selected to invoke at least one of a second widget and a second widget sub-collection representation 155-N.
   In an example embodiment, the first widget may be invoked simultaneously with the first widget sub-collection representation 155-N, and the second widget may be invoked simultaneously with the second widget sub-collection representation 155-N. In another example embodiment, the first widget may be a third widget sub-collection representation 155-N. In other words, a widget sub-collection representation 155-N is in itself, a widget that contains other widgets.

In step 219, the widget organizing process 140-2 renders a three dimensional presentation of the collection of widgets 165 on the mobile device display 150 as shown in FIG. 5. The presentation comprises a three dimensional association between at least one of:

i) the collection of widgets 165 and the first widget sub-collection representation 155-N and

ii) the first widget sub-collection representation 155-N and the second widget sub-collection representation 155-N.

In other words, the widget organizing process 140-2 renders a three dimensional presentation that displays the relationships between the collection of widgets 165, and any child widget sub-collection representation 155-N, and any nested widget sub-collection representations 155-N (i.e., grandchild widget sub-collection representations 155-N of the child widget sub-collection representations 155-N).

In step 220, the widget organizing process 140-2 allows a user 108 to select, via the three dimensional presentation, a selection of at least one of:
i) the collection of widgets 165
ii) the first widget representation 160-N
iii) the first widget sub-collection representation 155-N
iv) the second widget sub-collection representation 155-N and
v) the second widget representation 160-N
   The widget organizing process 140-2 displays the collection of widgets 165 and any associated widget sub-collection representations 155-N in a three dimensional representation as shown in FIG. 5. The user 108 may select any widget or widget sub-collection representation 155-N to render that widget on the mobile device display 150.

In step 221, the widget organizing process 140-2 renders the selection on the mobile device display 150. For example if the user 108 selected the widget sub-collection representation 155-3 (from either the widget sub-collection representation 155-4 or the widget sub-collection representation 155-3 itself), the widget organizing process 140-2 renders the widget sub-collection representation 155-3 on the mobile device display 150 of the mobile device 110. The user 108 could then select any of the widgets rendered on the widget sub-collection representation 155-3.

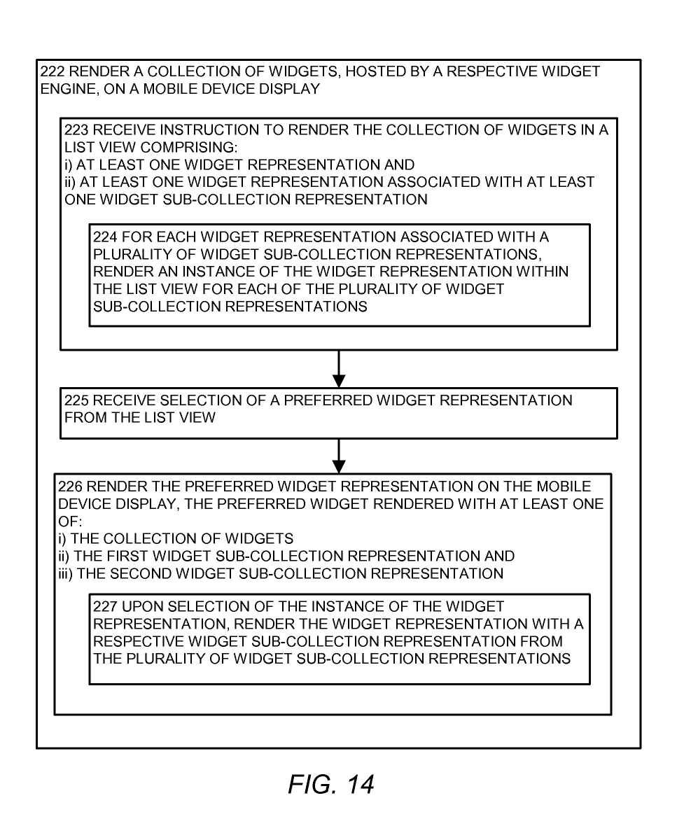

FIG. 14 is an embodiment of the steps performed by widget organizing process 140-2 when it renders a collection of widgets 165, hosted by a respective widget engine, on a mobile device display 150.

In step 222, the widget organizing process 140-2 renders a collection of widgets 165, hosted by a respective widget engine, on a mobile device display 150. The collection of widgets 165 comprises at least one of:
i) a first widget representation 160-N that, when selected, invokes a first widget and
ii) a first widget sub-collection representation 155-N that, when selected, invokes a plurality of widget representations 160-N, each of which may be selected to invoke at least one of a second widget and a second widget sub-collection representation 155-N.
   In an example embodiment, the first widget may be invoked simultaneously with the first widget sub-collection representation 155-N, and the second widget may be invoked simultaneously with the second widget sub-collection representation 155-N. In another example embodiment, the first widget may be a third widget sub-collection representation 155-N. In other words, a widget sub-collection representation 155-N is in itself, a widget that contains other widgets.

In step 223, the widget organizing process 140-2 receives instruction to render the collection of widgets 165 in a list view comprising:
i) at least one widget representation 160-N and
ii) at least one widget representation 160-N associated with at least one widget sub-collection representation 155-N
   In other words, when the user 108 selects list view, the widget organizing process 140-2 renders all the available widgets in a list view on the mobile device display 150 as shown in FIG. 7. FIG. 6 displays a mobile device display 150 rendering a widget sub-collection representation 155-N. The user 108 selects a list view option, and the widget organizing process 140-2 renders the list view of available widgets as shown in FIG. 7.

In step 224, the widget organizing process 140-2 for each widget representation 160-N associated with a plurality of widget sub-collection representations 155-N, renders an instance of the widget representation 160-N within the list view for each of the plurality of widget sub-collection representations 155-N. In an example embodiment, the same widget may exist on multiple widget sub-collection representations 155-N. For each instance of the widget, the widget organizing process 140-2 renders a separate widget representation 160-N entry within the list view. Thus, if the calendar widget is associated with three different widget sub-collection representations 155-N, when a user 108 selects list view, the widget organizing process 140-2 renders three instances of the calendar widget representation 160-N within the list view on the mobile device display 150.

In step 225, the widget organizing process 140-2 receives selection of a preferred widget representation 160-N from the list view. A user 108 may select a widget from the list view to render the widget sub-collection representation 155-N associated with that widget.

In step 226, the widget organizing process 140-2 renders the preferred widget representation 160-N on the mobile device display 150. The preferred widget is rendered with at least one of:
i) the collection of widgets 165
ii) the first widget sub-collection representation 155-N and
iii) the second widget sub-collection representation 155-N
   In other words, the widget organizing process 140-2 renders all the available widgets within the list view as shown in FIG. 7. The user 108 may select a widget representation 160-N, and the widget organizing process 140-2 renders that widget representation 160-N within the widget sub-collection representation 155-N associated with the widget, as shown in FIG. 8. FIG. 7 displays a user 108 selecting the “twitter” widget representation 160-21 from the list view. FIG. 8 shows the resulting widget sub-collection representation 155-5 rendered with associated widgets 160-N including the “twitter” widget representation 160-21 (that was selected from the list view). In an example embodiment, the user 108 may toggle between viewing the widget sub-collection representations 155-N, and list view, and then back to the widget sub-collection representation 155-N associated with a widget representation 160-N selected from the list view.

Upon selection of the instance of the widget representation 160-N, in step 227, the widget organizing process 140-2 renders the widget representation 160-N with a respective widget sub-collection representation 155-N from the plurality of widget sub-collection representations 155-N. In an example embodiment, the same widget may exist on multiple widget sub-collection representations 155-N. For each instance of the widget representation 160-N, the widget organizing process 140-2 renders a separate widget entry within the list view. Thus, if the calendar widget is associated with three different widget sub-collection representations 155-N, when a user 108 selects list view, the widget organizing process 140-2 renders three instances of the calendar widget representation 160-N within the list view on the mobile device display 150. Thus, depending on which instance of the widget representation 160-N that the user 108 selects, the corresponding widget sub-collection representation 155-N will be rendered on the mobile device display 150.

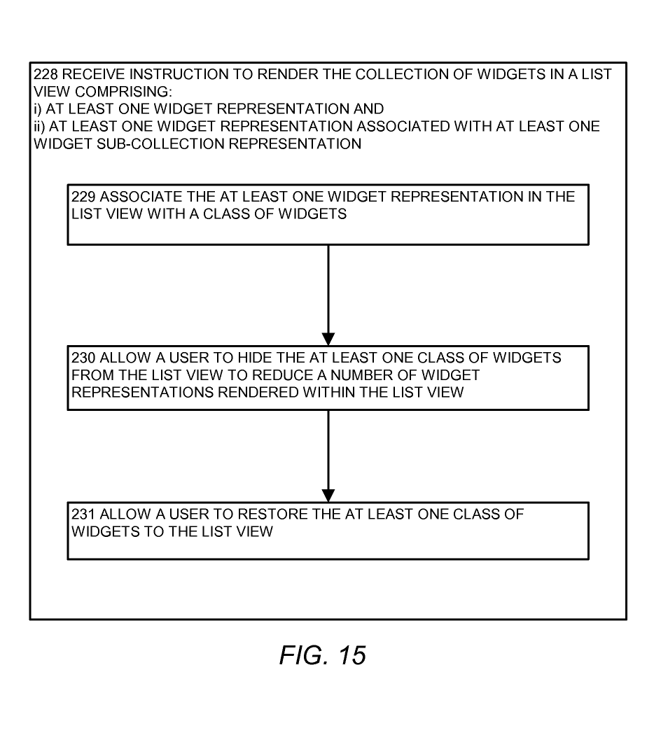

FIG. 15 is an embodiment of the steps performed by widget organizing process 140-2 when it receives instruction to render the collection of widgets 165 in a list view.

In step 228, the widget organizing process 140-2 receives instruction to render the collection of widgets 165 in a list view comprising:
i) at least one widget representation 160-N and
ii) at least one widget representation 160-N associated with at least one widget sub-collection representation 155-N
   When the user 108 selects list view, the widget organizing process 140-2 renders all the available widgets in a list view on the mobile device display 150 as shown in FIG. 7. FIG. 6 displays a mobile device display 150 rendering a widget sub-collection representation 155-N. The user 108 selects a list view option, and the widget organizing process 140-2 renders the list view of available widget representations 160-N as shown in FIG. 7.

In step 229, the widget organizing process 140-2 associates at least one widget representation 160-N in the list view with a class of widgets. In an example embodiment, the widget organizing process 140-2 categorizes the widgets according to a widget class. For example, clock widgets would be categorized into a clock related class.

In step 230, the widget organizing process 140-2 allows a user 108 to hide at least one class of widgets from the list view to reduce a number of widget representations 160-N rendered within the list view. To make widget selection from the list view easier, the user 108 may hide one or more classes of widgets from the list view. This reduces the number of widget representations 160-N displayed in the list view, and facilitates the user 108 in locating the preferred widget.

In step 231, the widget organizing process 140-2 allows a user 108 to restore at least one class of widgets to the list view. In an example embodiment, the user 108 may restore hidden classes of widgets to the list view.

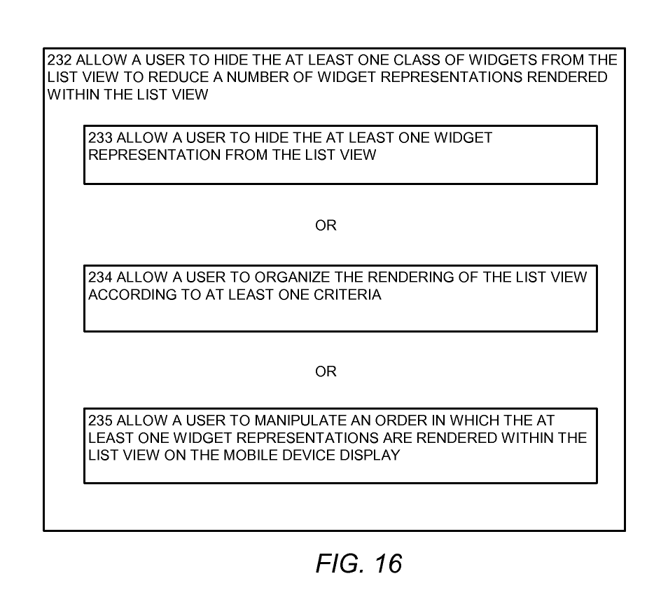

FIG. 16 is an embodiment of the steps performed by widget organizing process 140-2 when it allows a user 108 to hide at least one class of widgets from the list view to reduce a number of widget representations 160-N rendered within the list view.

In step 232, the widget organizing process 140-2 allows a user 108 to hide at least one class of widgets from the list view to reduce a number of widget representations 160-N rendered within the list view.

In step 233, the widget organizing process 140-2 allows a user 108 to hide at least one widget representation 160-N from the list view. In an example embodiment, the user 108 can selectively hide individual widget representations 160-N from the list view on the mobile device display 160.

Alternatively in step 234, the widget organizing process 140-2 allows a user 108 to organize the rendering of the list view according to at least one criteria. For example, the user 108 may organize the list view alphabetically, by widget type, according to the widget sub-collection representation 155-N with which the widget is associated, most frequently used, etc.

Alternatively in step 235, the widget organizing process 140-2 allows a user 108 to manipulate an order in which at least one widget representation 160-N is rendered within the list view on the mobile device display 150. In an example embodiment, the user 108 may manually order the widget within the list view by dragging and dropping the widgets on the mobile device display 150.

While computer systems and methods have been particularly shown and described above with references to configurations thereof, it will be understood by those skilled in the art that various changes in form and details may be made therein without departing from the scope disclosed herein. Accordingly, the information disclosed herein is not intended to be limited by the example configurations provided above.

What is claimed is:

1. A computer implemented method of organizing a collection of widgets on a mobile device display, the method comprising:
rendering a collection of widgets, hosted by a respective widget engine, on a mobile device display, the collection of widgets comprising at least one of:
i) a first widget representation that, when selected, invokes a first widget; and
ii) a first widget sub-collection representation that, when selected, invokes a plurality of widget representations, each of which may be selected to invoke at least one of a second widget and a second widget sub-collection representation
wherein the first widget may be invoked simultaneously with the first widget sub-collection representation and the second widget may be invoked simultaneously with the second widget sub-collection representation and wherein the first widget may be a third widget sub-collection representation.

2. The method of claim 1 wherein rendering a collection of widgets comprises:
applying at least one policy to at least one widget sub-collection representation, the policy restricting which widgets may be associated with the at least one widget sub-collection representation.

3. The method of claim 1 wherein rendering a collection of widgets comprises:
automatically organizing a subset of the widgets in the collection of widgets into at least one widget sub-collection representation; and
rendering the at least one widget sub-collection representation on the mobile device display.

4. The method of claim 3 wherein automatically organizing a subset of the widgets in the collection of widgets into at least one widget sub-collection representation comprises:
detecting that the subset of the widgets has not been selected by a user within a predetermined period of time; and
identifying the subset for compilation into the at least one widget sub-collection representation.

5. The method of claim 3 comprising:
allowing a user to modify the at least one widget sub-collection representation.

6. The method of claim 5 comprising:
providing at least one recommendation, to the user, for modification of the at least one widget sub-collection representation.

7. The method of claim 1 wherein rendering a collection of widgets comprises:
detecting that a number of widgets rendered on the mobile device display has exceeded a display threshold; and
transmitting a recommendation, to a user, to organize a subset of the widgets in the collection of widgets into at least one widget sub-collection representation.

8. The method of claim 7 comprising:
recommending, to the user, which of the subset of widgets to organize into the at least one widget sub-collection representation.

9. The method of claim 1 wherein rendering a collection of widgets comprises:
allowing a user to customize an appearance associated with at least one widget sub-collection representation.

10. The method of claim 1 comprising:
allowing at least one user to transfer at least one widget sub-collection representation to a storage system for retrieval by at least one other user.

11. The method of claim 10 comprising:
allowing the at least one other user to download the at least one widget sub-collection representation; and
allowing the at least one other user to modify the at least one widget sub-collection representation.

12. The method of claim 1 comprising:
rendering a three dimensional presentation of the collection of widgets on the mobile device display, the presentation comprising a three dimensional association between at least one of:
i) the collection of widgets and the first widget sub-collection representation; and
ii) the first widget sub-collection representation and the second widget sub-collection representation.

13. The method of claim 12 comprising:
allowing a user to select, via the three dimensional presentation, a selection of at least one of:
i) the collection of widgets;
ii) the first widget representation;
iii) the first widget sub-collection representation;
iv) the second widget sub-collection representation; and
v) the second widget representation; and
rendering the selection on the mobile device display.

14. The method of claim 1 comprising:
receiving instruction to render the collection of widgets in a list view comprising:
i) at least one widget representation; and
ii) at least one widget representation associated with at least one widget sub-collection representation;
receiving selection of a preferred widget representation from the list view; and
rendering the preferred widget representation on the mobile device display, the preferred widget rendered with at least one of:
i) the collection of widgets;
ii) the first widget sub-collection representation; and
iii) the second widget sub-collection representation.

15. The method of claim 14 wherein receiving instruction to render the collection of widgets in a list view comprises:
for each widget representation associated with a plurality of widget sub-collection representations, rendering an instance of the widget representation within the list view for each of the plurality of widget sub-collection representations; and
wherein rendering the preferred widget representation on the mobile device display comprises:
upon selection of the instance of the widget representation, rendering the widget representation with a respective widget sub-collection representation from the plurality of widget sub-collection representations.

16. The method of claim 14 wherein receiving instruction to render the collection of widgets in a list view comprises:
associating the at least one widget representation in the list view with a class of widgets; and
allowing a user to hide the at least one class of widgets from the list view to reduce a number of widget representations rendered within the list view.

17. The method of claim 16 comprising:
allowing a user to restore the at least one class of widgets to the list view.

18. The method of claim 14 comprising:
allowing a user to hide the at least one widget representation from the list view.

19. The method of claim 14 comprising:
allowing a user to organize the rendering of the list view according to at least one criteria.

20. The method of claim 14 comprising:
allowing a user to manipulate an order in which the at least one widget representations are rendered within the list view on the mobile device display.
